(19) United States
(12) Patent Application Publication
(10) Pub. No.: US 2016/0366286 A9
(43) Pub. Date: Dec. 15, 2016

(54) RINGTONE CALLER ID

(71) Applicant: Jason A. Ashton, Santa Cruz, CA (US)

(72) Inventor: Jason A. Ashton, Santa Cruz, CA (US)

(21) Appl. No.: 14/176,786

(22) Filed: Feb. 10, 2014

Related U.S. Application Data
(63) Continuation-in-part of application No. 13/547,224, filed on Jul. 12, 2012, now abandoned.
(60) Provisional application No. 61/507,953, filed on Jul. 14, 2011.
(60) Provisional application No. 61/537,969, filed on Sep. 22, 2011.

(51) Int. Cl. H04M 19/04; H04W 4/16

(52) U.S. Cl. CPC H04M 19/041; H04W 4/16

(57) ABSTRACT

A device provides a sender-selected notification. In one embodiment, upon an incoming message from the sender, the device provides a warning notification followed by the sender-selected notification. In one embodiment, the sender-selected notification is associated with a commercial offer. In one embodiment, the phone concurrently provides a visual display identifying the caller by name, the identification not requiring a user of the phone to associate a name with a phone number. In one embodiment, the phone allows for sender-selected notifications to be disabled for a caller.

### CLAIM OF PRIORITY

This application is a continuation-in-part that claims priority to U.S. application Ser. No. 13/547,224 entitled: “PHONE WITH MULTI-PORTAL ACCESS FOR DISPLAY DURING INCOMING AND OUTGOING CALLS”, by Jason A. Ashton, filed Jul. 12, 2012, and to U.S. Application No. 61/507,953 entitled: “PHONE WITH MULTI-PORTAL ACCESS FOR DISPLAY DURING INCOMING AND OUTGOING CALLS”, by Jason A. Ashton, filed Jul. 14, 2011, and to U.S. Application No. 61/537,969 entitled: “PHONE WITH MULTI-PORTAL ACCESS FOR DISPLAY DURING INCOMING AND OUTGOING CALLS”, by Jason A. Ashton, filed Sep. 22, 2011, which are all incorporated herein by reference.

### BACKGROUND

Today there are many devices that provide notifications for incoming messages, calls, emails, text and the like. These devices can offer advanced computing ability and connectivity. By way of example, Smartphones combine the functions of a personal digital assistant (PDA) and a mobile phone. Today's models typically also serve as portable media players and camera phones with high-resolution touchscreen, GPS navigation, Wi-Fi and mobile broadband access. Smartphone's use mobile operating systems that can run third-party applications.

Growth in demand for advanced mobile devices boasting powerful processors and graphics processing units, abundant memory, and high-resolution screens with multi-touch capability, and open operating systems has outpaced the rest of the mobile phone market for several years. Over 45.5 million people in the United States own Smartphones out of 234 million total subscribers.

Today's devices provide notifications (ringtones) for incoming messages, calls, emails, text and the like. Further, the notification functionality and process of current devices are is limited and can only set a custom ringtone for incoming calls—on their device only Similarly, today's devices only allow the receiving party to change or customize notifications for all emails and text messages as a group. In other words, current devices that provide notifications for incoming emails or text messages are not able to customize and assign a different notification for each individual sender of a text or email. Further, current devices that provide notifications for incoming texts and emails provide notifications that are only in audio. Embodiments of the present invention allow the sender of a text message, email, information, incoming call and the like the option to customize and assign a notification that will be heard and/or seen by the recipient that was selected by the sender.

### SUMMARY

Embodiments of the present invention address the limitations of today's devices that provide notifications for incoming calls, text messages, emails and the like. Embodiments of the present invention allow a caller or sending party of information (sender) the ability to determine and select the notification (such as reverse ringtone) heard on the recipient device. Embodiments of the present invention concern a device that allows a caller or sender of information the ability and option to provide a sender-selected notification, such as a ringtone, image, audio, custom message, live voice and/or video or recording selected by the caller or sender of information (“sender”). Embodiments of the present invention provide notifications that can be in the form of a ringtone, image, audio, custom message, live voice and/or images or recording selected by the caller or sender of information and heard by the receiving party's device.

A device has a default first notification that is normally provided by the device upon incoming messages from a caller or sender. Embodiments of the present invention provide a sender-selected notification. The notification being provided to the receiving device is selected by the caller or sender and is heard and/or seen by recipient upon an incoming call, text message, email and the like from the sender. In one embodiment, a notification selected by a caller or sender is used to replace a standard default or custom ringtone selected by recipient. For example, a caller can replace a ringtone with a specific song or recorded message so as to surprise the recipient or remind the recipient of a shared experience or the like.

Embodiments of the present invention can allow the sender the ability to replace the default audio or visual notifications on receiving party's device, feature phones, television monitor and mobile devices with sending party's choice of audio, visual, audio visual and/or visual images as sender-selected notifications that are displayed and heard on receiving party's device. Devices can include phones, televisions, monitors or mobile devices for incoming calls, emails, text messages and the like.

Currently devices provide notifications, only for incoming calls. A custom ringtone be selected by the receiving party to be different from the generic default ringtone provide by device's manufacture as a method for receiving party to distinguish a particular incoming caller. Today only receiving party can replace the default ringtone and only for incoming calls.

Embodiments of the present invention can allow sending party the option to provide sender-selected notifications. In this way, sending party can now select and determine what notifications (ringtones) are heard on receiving party's device

The system can store sender-selected notifications on the client (e.g. device, mobile device, television, monitor and/or phone) and/or on a server located locally or remotely (e.g. cloud).

In one embodiment, upon an incoming message from the sender, the device provides a warning notification followed by the sender-selected notification. In one embodiment, the sender-selected notification is associated with a commercial offer. In one embodiment, the phone concurrently provides a visual display identifying the caller by name, the identification not requiring a user of the phone to associate a name with a phone number. In one embodiment, the phone allows for sender-selected notifications to be disabled for a caller.

### BRIEF DESCRIPTION OF THE DRAWINGS

FIG. 1 shows an exemplary phone indicating an incoming call with a normal ringtone.

FIG. 2A shows an exemplary phone indicating an incoming call with a reverse ringtone.

FIG. 2B shows an exemplary phone indicating an incoming call with a warning notification and a reverse ringtone.

FIG. 2C shows an exemplary phone indicating an incoming call with a warning notification, a normal ringtone and reverse ringtone.

FIG. 2D shows an exemplary phone in which a sender selected notification is used as a dial tone at the sending phone.

FIG. 3 shows an exemplary display of an embodiment of the present invention that can be used to select reverse notification settings for a caller.

FIGS. 4A and 4B show the use of a sender-selected notification associated with a commercial offer.

FIG. 5 shows the use of a sender-selected notification along with a visual display of an identification of a sender.

FIG. 6 shows an exemplary display of an embodiment of the present invention that can be used to select permissions for a reverse ringtone.

FIG. 7 shows an exemplary display of an embodiment of the present invention that can be used to select a reverse ringtone for a recipient.

FIG. 8 shows a flow chart of an embodiment of the present invention.

FIG. 9 shows an exemplary system of one embodiment of the present invention.

FIG. 10 shows a screen for emergency features of a phone of one embodiment.

FIG. 11 shows a flow chart of one embodiment.

FIG. 12 shows an emergency system of one embodiment.

### DETAILED DESCRIPTION

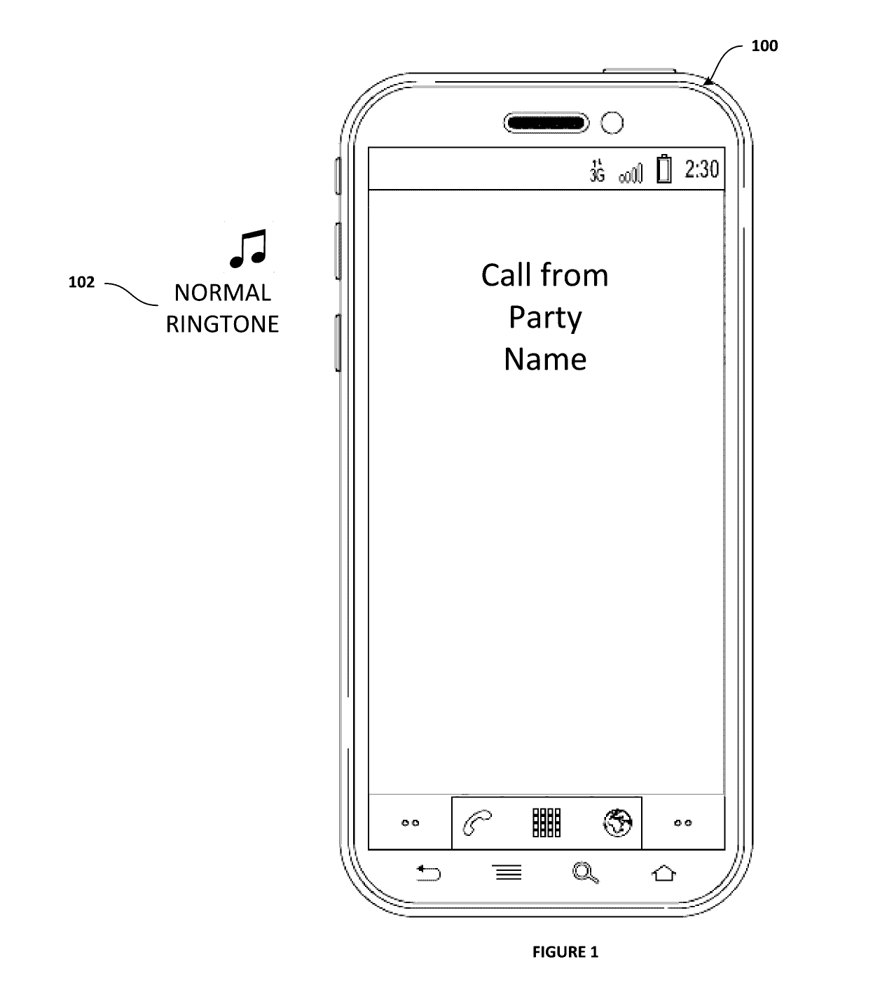

In FIG. 1, a device 100 produces a default or custom notification upon a message from a caller or sender. The device 100 can be a device, such as a mobile phone, smart television, and the like. Alternately the device can be a stationary device. The first notification can be an audio notification such as a ringtone. For example, the message can be a call with the audio notification being a default ringtone 102. The normal ringtone 102 can be a default phone ringtone, a uniform ringtone selected by the user of the device for all incoming calls, or a custom ringtone for each individual selected by the user of the phone for incoming calls. The message can also be a text message, or email for which a first notification, such as an audio notification, is provided but on today's devices only allow a single notification to represent the entire text message as a group and does not allow for customized ringtone for each individual text message sender; the same limitation exits for incoming emails.

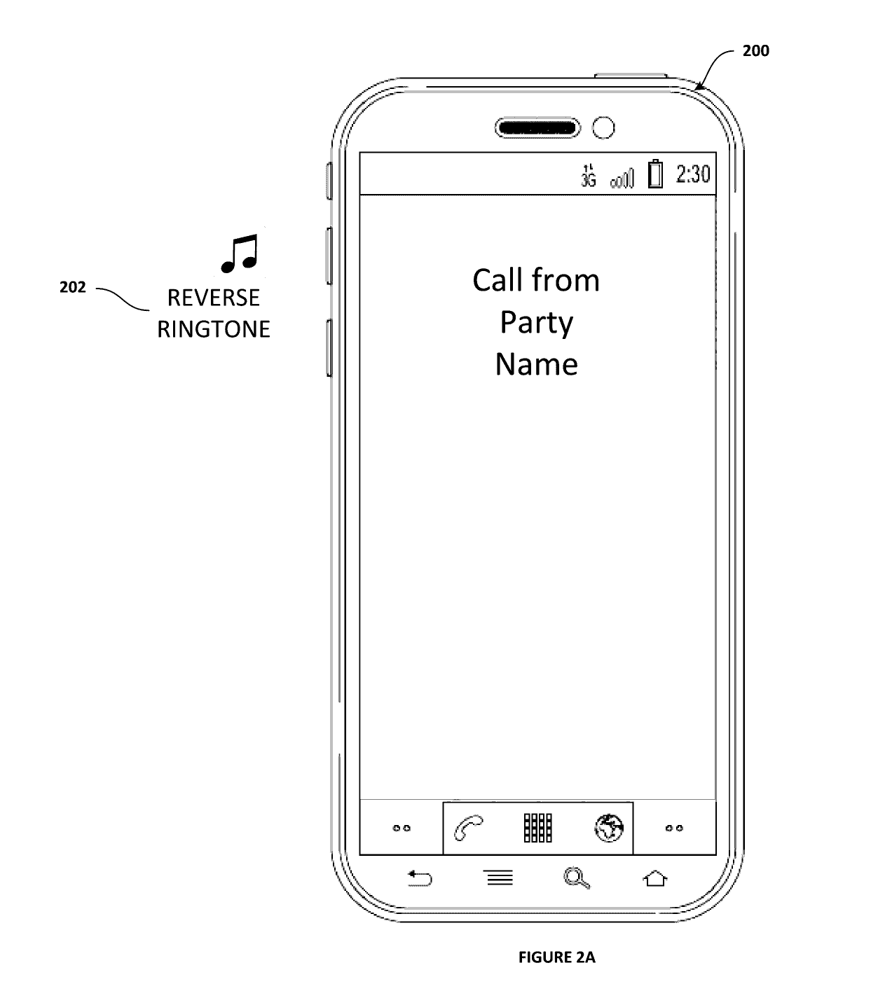

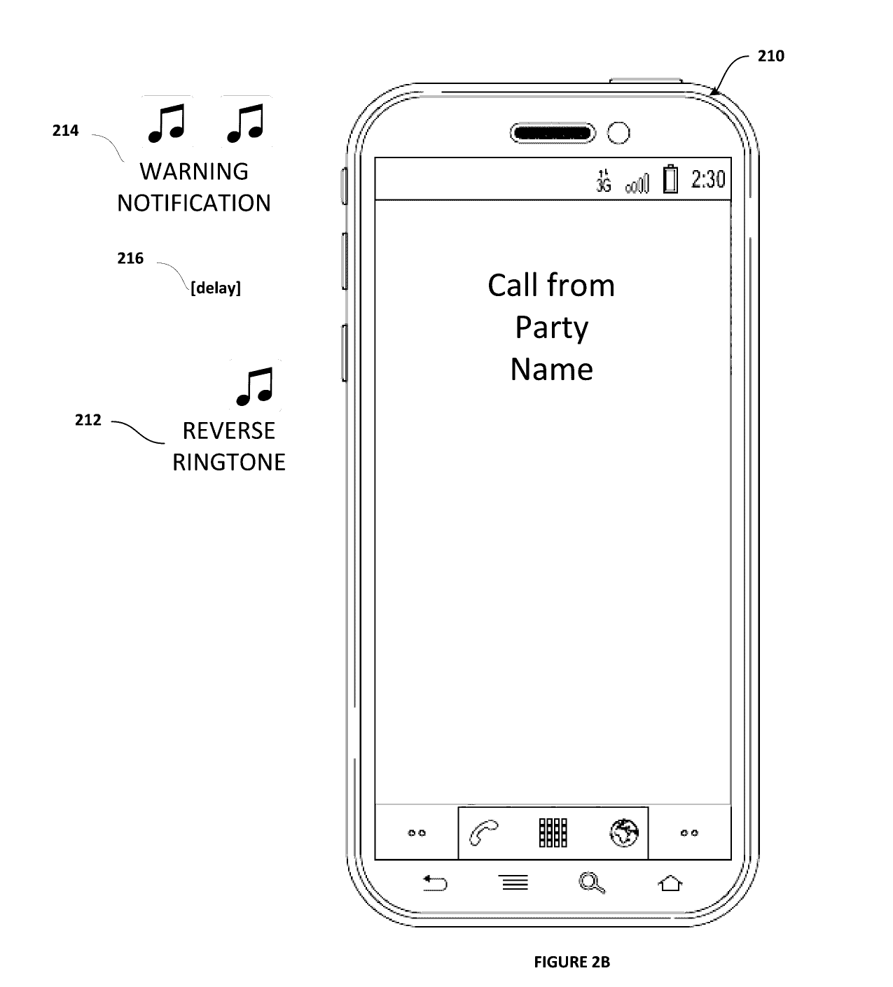

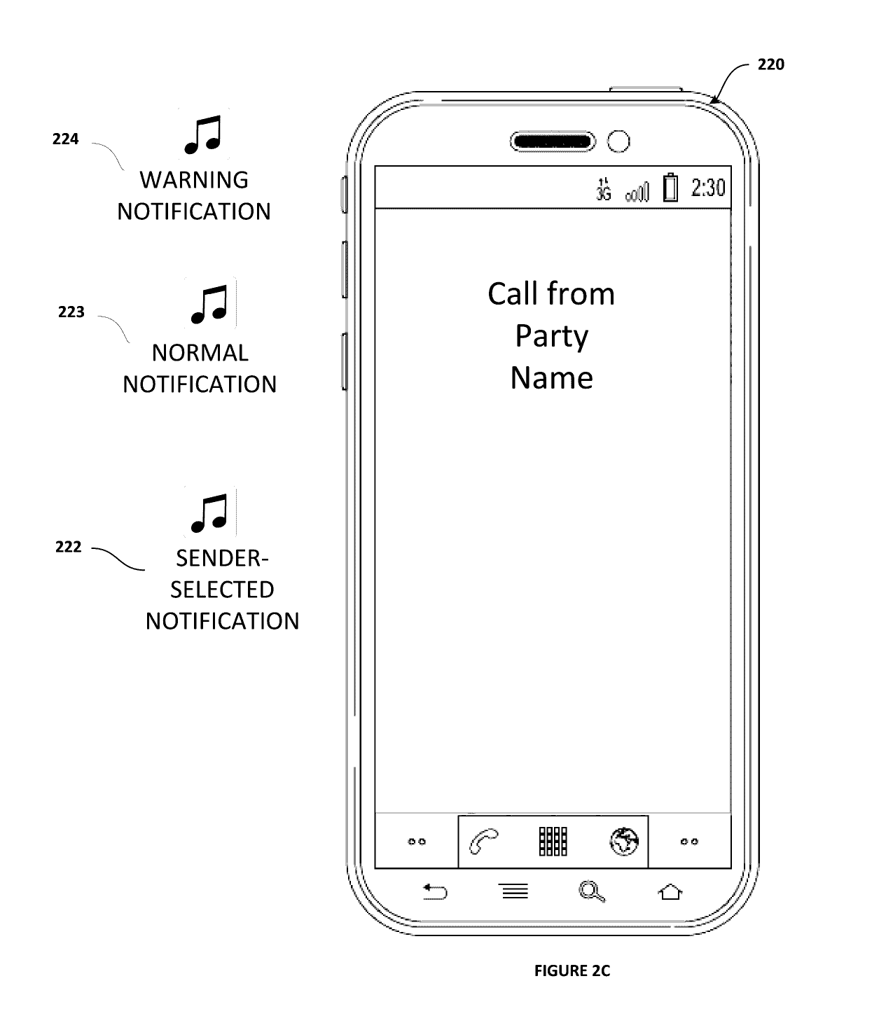

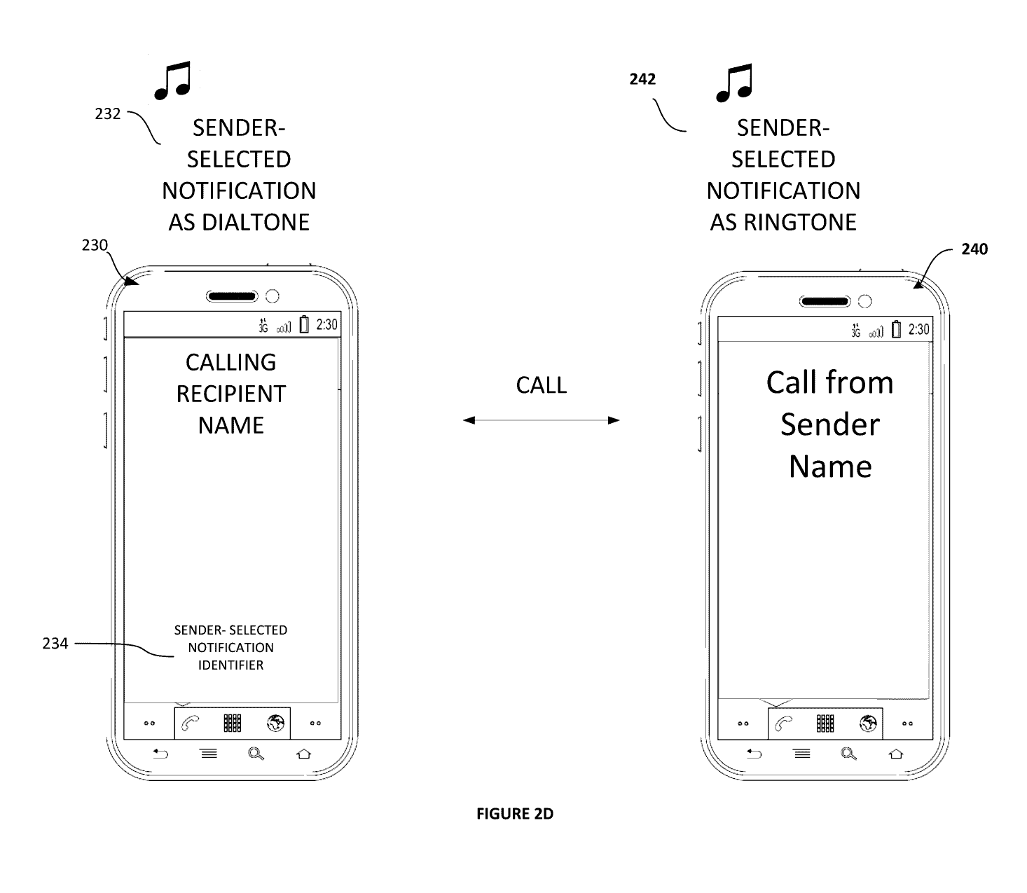

FIG. 2A shows a device 200 in which a sender-selected notification 202 selected by the caller is provided. The sender-selected notification can be a ringtone or any other notification. It is typically distinct from call or other message.

In one embodiment, the sender-selected notification 202 is selected and initiated by the caller or sender of information (e.g. text message, email, etc.) rather than the recipient. A caller or sender can select the sender-selected notification 202 for a single message or set the notification for all of the messages to the device.

As shown in FIG. 2A, the sender-selected notification can be an alternate ringtone that is provided for a call, text or email from the sender who selected the ringtone that is heard and/or seen on the recipient's device. In embodiments of the present invention, this alternate ringtone can be considered to be a reverse ringtone since rather than the conventional default or custom ringtone that is selected by the caller rather than by the recipient. Alternately the sender-selected notification can be a video, an audio message recorded by the caller, or any other form of digital media in the form of a notification of the message that was selected by the sender and heard on recipient device.

In the example of FIG. 2A, the sender-selected notification 202 replaces the default ringtone or custom ringtone selected by the user of the device receiving the call with the sender-selected notification 202.

As shown in FIG. 2B, in one embodiment, upon an incoming message from the sender, the device 210 provides a warning notification 214 followed by the sender-selected notification 212. The warning notification 214 can indicate to the user of the device that the sender-selected notification 212 is coming That can give the user additional comfort with sender-selected notifications 212 like reverse ringtones. In one embodiment, a delay 216 between the warning notification and the sender-selected notification is selectable at the device. Longer delays can be selected by users who are less comfortable with the use of sender-selected notifications and other reverse ringtones.

As shown in FIG. 2C, in one embodiment, upon an incoming message from the sender, the device 220 provides the normal notification 223 followed by the sender-selected notification 222. The normal notification can be the custom or default notification that is usually provided for the caller. When the normal notification 224 is a custom notification, this can allow the user to determine the identity of the caller. In one embodiment, the normal notification 223 is proceeded by a warning notification 224.

In one embodiment, the sender-selected notification can be an emergency message. For example, enabled devices can interrupt calls during emergencies by replacing ringtones with live voice, or replacing ringtones with emergency message.

In one embodiment, an operating system or application on the device checks to determine if there is a sender-selected notification from sender to replace or be provided in addition to the default or custom ringtone selected by receiving party for incoming calls or incoming information If there is such a sender-selected notification for which the recipient has given permission to sender to allow the sender to select and sender-selected the ringtone on recipient device then the device provides the sender-selected notification.

FIG. 2D shows a sending device 230 and receiving device 240 of one embodiment of the present invention. The sending device can be used to select a sender-selected notification for a message at a receiving device. The receiving device 240 and sending device 230 both use the sender-selected notification for the message.

In one embodiment, the sending device is a phone 230 in which a sender selected notification 232 is used as a dial tone at the sending phone 230. A dial tone being any audio indication of a call being made. This allows the sender to be reminded of the sender selected notification 232 for the recipient. The sender can then change or correct the sender selected notification 232 as needed. A visual indication 234 of the sender-selected notification can also be displayed at the sending phone 230. The visual indication can use information such as name, recording date and/or time information or the like. The receiving phone 240 can then provide the sender selected notification 242 as the ringtone. The sender selected notification can be played for other messages such as texts and emails as well as calls.

In one embodiment, the user selected notification can play in the background during the call. This can be done at a reduced volume as a type of background music. This background playing of the user selected notification can be for a limited period of time, until turned off, or for the entire call.

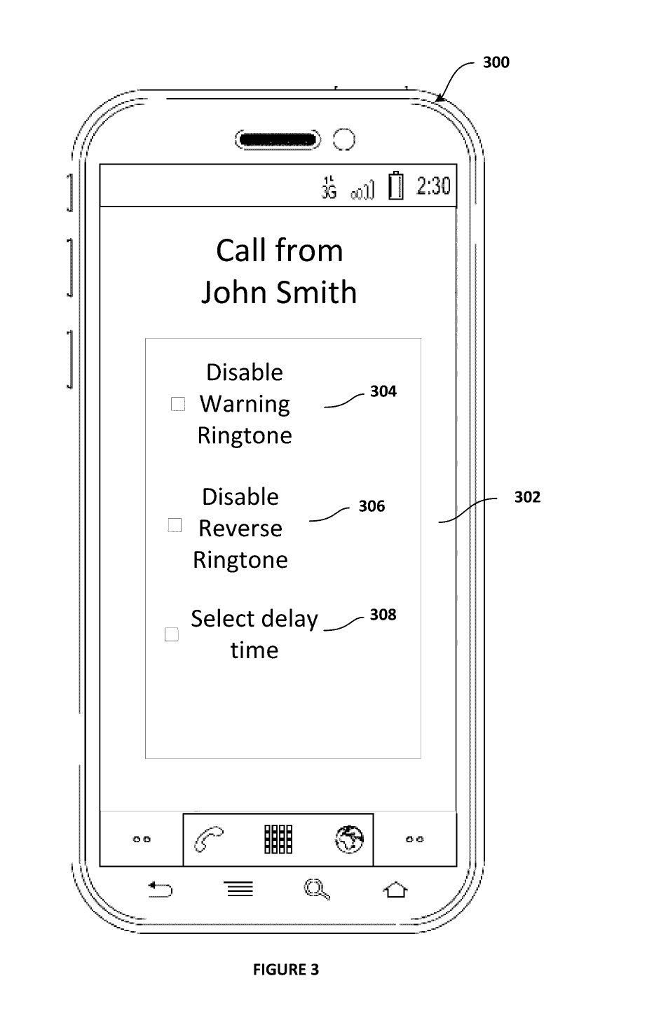

In one embodiment, the device can allow for a user to select which possible senders need not have a warning notification before the sender-selected notification. This can allow the user to let certain people provide a sender-selected notification without the warning notification. In one embodiment, the warning notification can be the default for unknown callers. FIG. 3 shows an example where a screen 302 on a device 300 can be used to disable warning indications 304 for a caller.

In one embodiment, the user can select if sender-selected notifications are to be disabled for a sender. In that case, the normal notification can be provided for future messages despite the sender selecting a sender-selected notification. FIG. 3 shows an example where a screen 302 on a device 300 can be used to sender-selected notifications 306 for a caller.

In one embodiment, a display 302 upon a message, such as a call, can allow the user to adjust settings related to the sender-selected notification. For example, the display 302 can allow the warning time between a warning notification and the sender-selected notification to be adjusted 308, remove the warning notification for a sender 304, or remove the sender-selected notification for a sender 306.

Other selectable options can allow the use of the normal notification along with the sender-selected notification, or the use of the warning notification and normal notification along with the sender-selected notification.

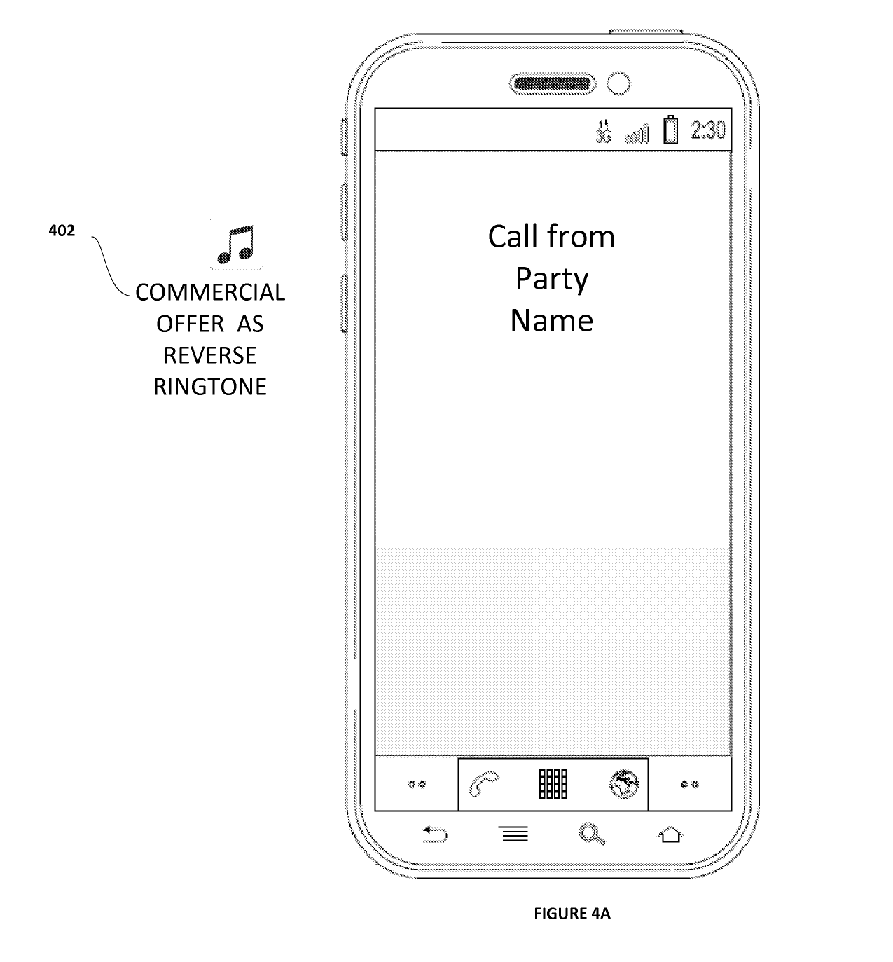

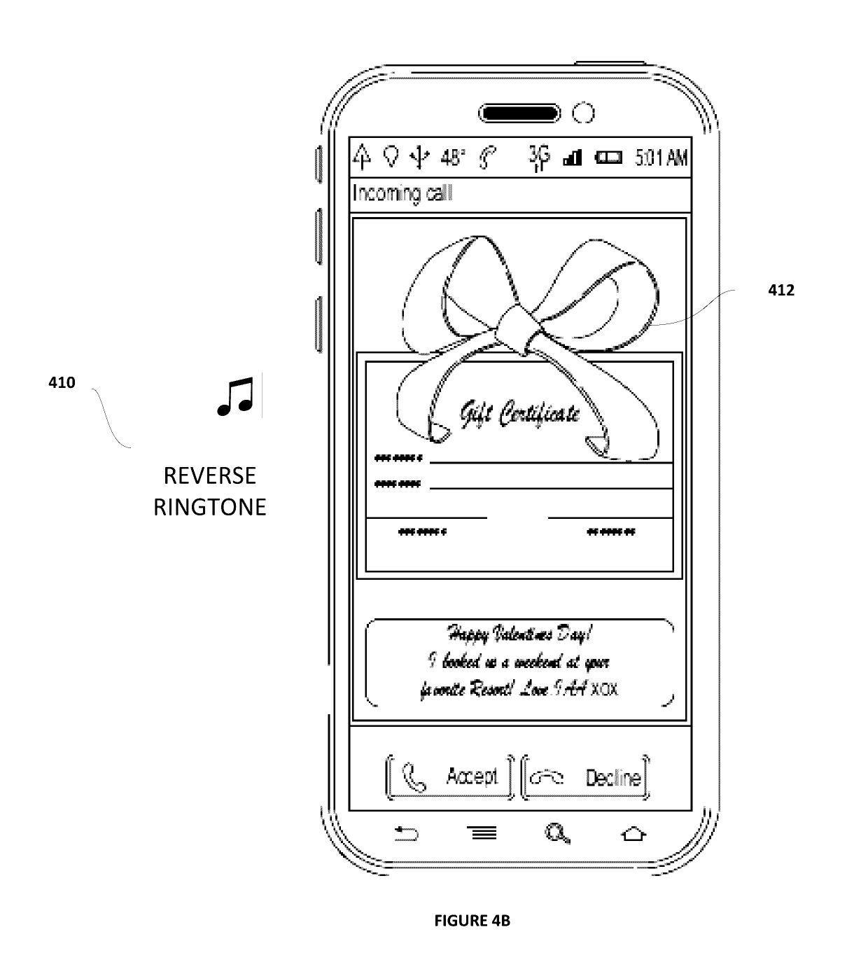

In one embodiment, the sender-selected notification is associated with a commercial offer. For example, the commercial offer can be an ad, a coupon or a gift certificate. As shown in FIG. 4B, the commercial offer 412 can displayed along with the sender-selected notification 410. Alternately, as shown in FIG. 4A, the sender-selected notification 402 can be the commercial offer. For example reverse ringtone can be an audio commercial. The receiver can get a benefit such as a financial benefit for receiving or being able to receive commercial offers. In one embodiment, such offers can be blocked at the receiving device if desired.

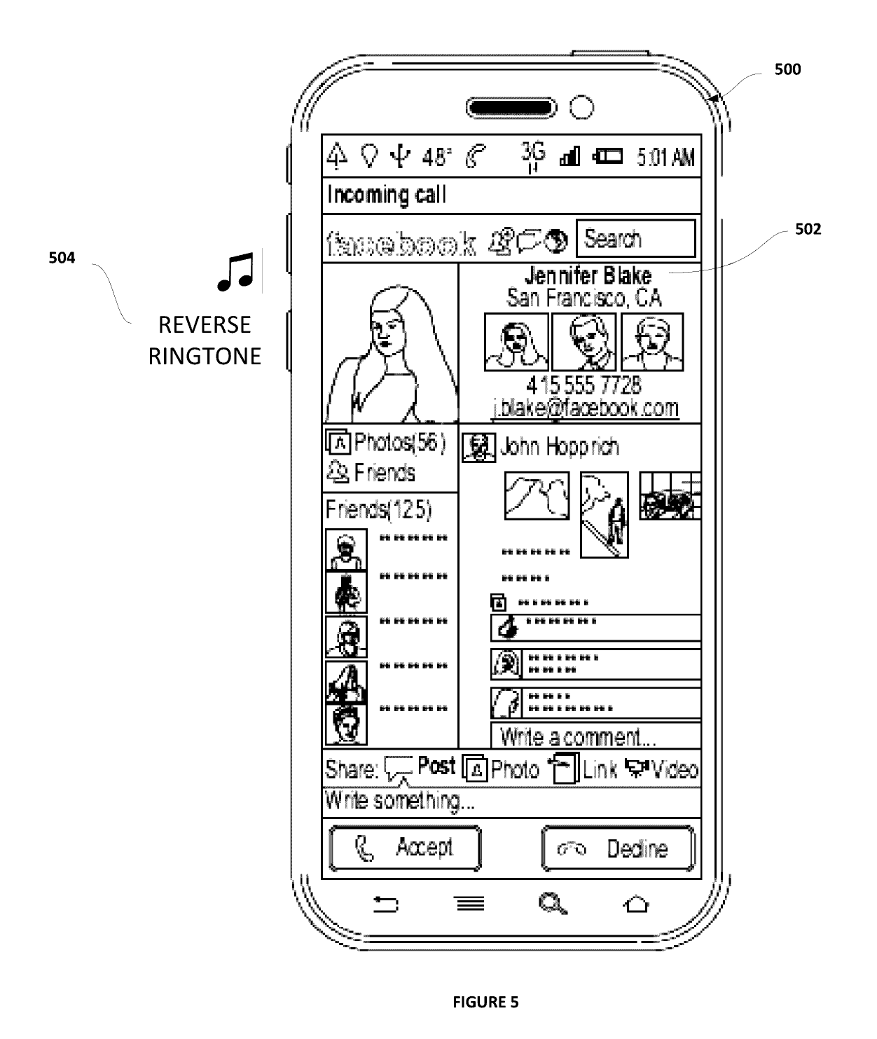

As shown in FIG. 5, the phone 500 can concurrently provide a visual display 502 along with the sender-selected notification 504. The visual display 502 can identify the caller by name. The identification 502 need not require a user of the phone to associate a name with a phone number.

A reverse lookup can used to determine the identification. For example, a reverse look up system can be used to determine the caller's name. In one embodiment, a display system like that described in U.S. application Ser. No. 13/547,224 entitled: “PHONE WITH MULTI-PORTAL ACCESS FOR DISPLAY DURING INCOMING AND OUTGOING CALLS” and incorporated herein by reference can be used.

In one embodiment, the sender-selected notification system can require a registration that authenticates the senders name or allows users to get kicked off the system for using false names. The system can also be used to filter or control the used of reverse notifications.

In one embodiment, the device is part of an open system that defaults to allowing senders to provide the sender-selected notifications. Thus anyone can use the sender selected notifications.

In one embodiment, the open system can be enabled with the use of an application that can be obtained from a phone based app store, such as one for iPhone or Android. Such an app can be used to link the sender to an accurate identification that is provided along with the sent message. The app can be used to require the user to input identification information and tie this information with a device identifier, such as a phone number. The app can also be used to censor sender-selected notifications and ban abusers of the system.

Sender-selected notifications can be analyzed then censored if they are undesirable. The analysis can be used to provide an indication of the sender-selected notification that can be provided to the receiving device. For example, the indication can be provided during a warning period before the sender-selected notification is provided.

In one embodiment, the sender-selected notification such as the reverse ringtone is analyzed to determine the identification. For example, voice identification software can be used. Alternately, a database of sender-selected notification fingerprints can be used.

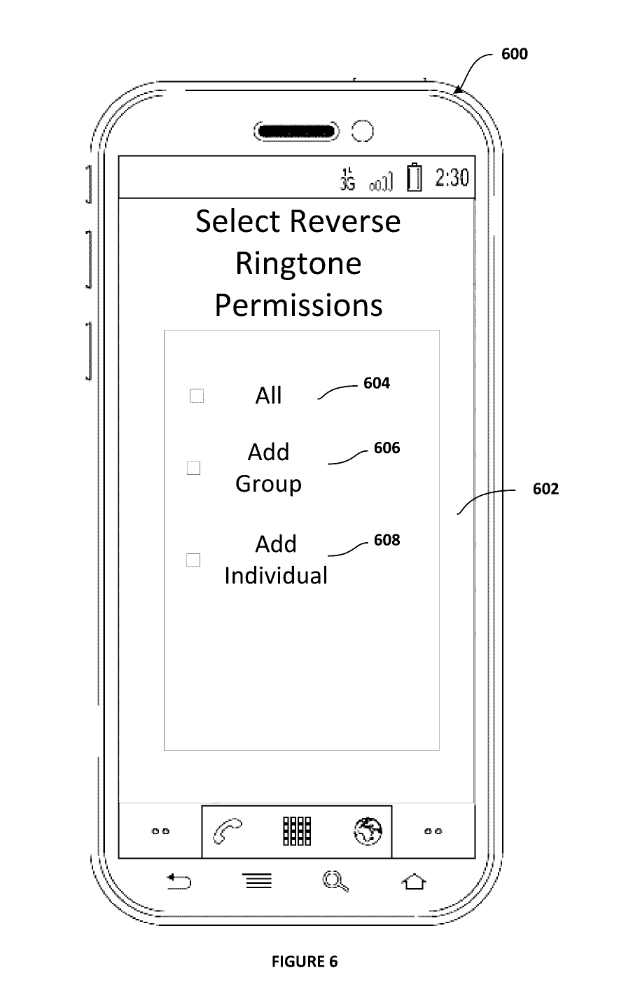

As shown in FIG. 6, the device 600, such as a mobile phone, can allow a user (recipient) to select which possible senders are allowed to provide sender-selected notifications. For example, the device 600 can allow the user to select a previously defined group of callers and/or senders to be able to provide sender-selected notifications. The groups can be defined in the user's contacts for example. Alternately, the group can be defined with data from a third party website. For example, the user can allow permission for all of the users' Facebook friends to provide a ringtone selected by the senders of information using data obtained from Facebook.

In FIG. 6, a graphical user interface (GUI) 602 can allow for the user to select the desired level of permissions. In this example, the GUI 602 can allow permissions to be selected for all 604, groups 606 or individuals 608. Senders who the user has allowed to provide the sender-selected notifications will have permission; others may be blocked. Permissions for the allowing the caller or sender the ability to provide the sender-selected notifications can be set on or off as a default.

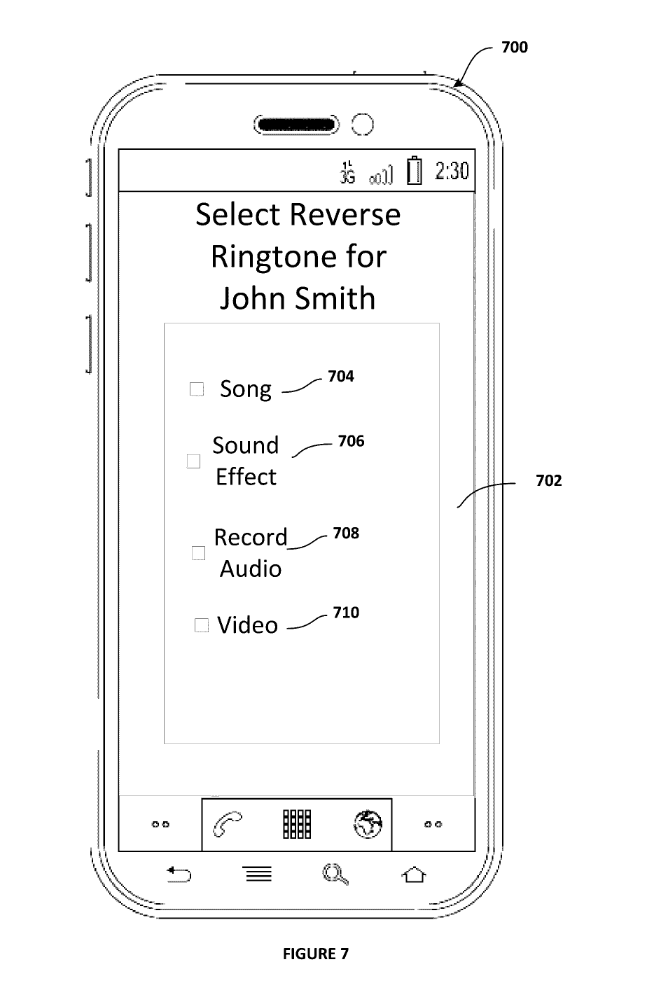

FIG. 7 shows a device 700 that allows a sender to select a sender-selected notification (such as a reverse ringtone) using GUI 702. In this case, GUI 702 allows the selection of a variety of types of sender-selected notifications such as songs 704, sound effects 706, recorded audio 708, or video 710. The selected sender-selected notification can be for a single recipient, for a group or for all message/call recipients. The use can be for a single message/call or for all messages/calls sent to a recipient.

For example, a business can have its employees use a reverse ringtones that promote, advertise or represent the company for all calls, texts and emails.

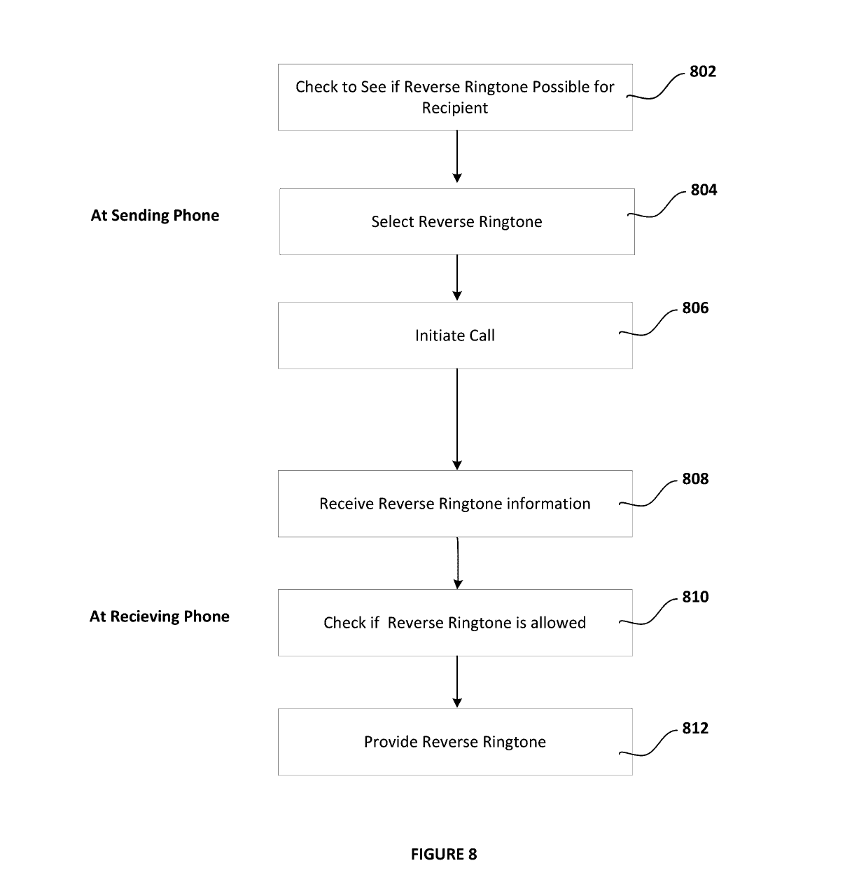

FIG. 8 shows a flowchart for one exemplary embodiment using reverse ringtones as the sender-selected notification. The steps shown here can be omitted, reordered or replaced in other embodiments.

In step 802, a check is done to determine if the recipient of a call, text or email allows the sender-selected of the default or custom ringtone selected by the recipient of the call, message or email with a sender-selected notification (reverse ringtone). For example, the system can check to see if a recipient allows for a reverse ringtones. Alternately, such a check need not be done. In step 804, the reverse ringtone is selected by the caller or sender of information. In step 806, the call is initiated.

In step 808, the receiving phone gets ringtone information. This may or may not include a reverse ringtone, a link to a reverse ringtone or another way to determine the reverse ringtone. In step 810, it is checked to see if the reverse ringtone is allowed by the receiving phone. In step 812, if the reverse ringtone is permitted, the receiving phone provides the sender-selected notification, such as by substituting the reverse ringtone for the normal ringtone.

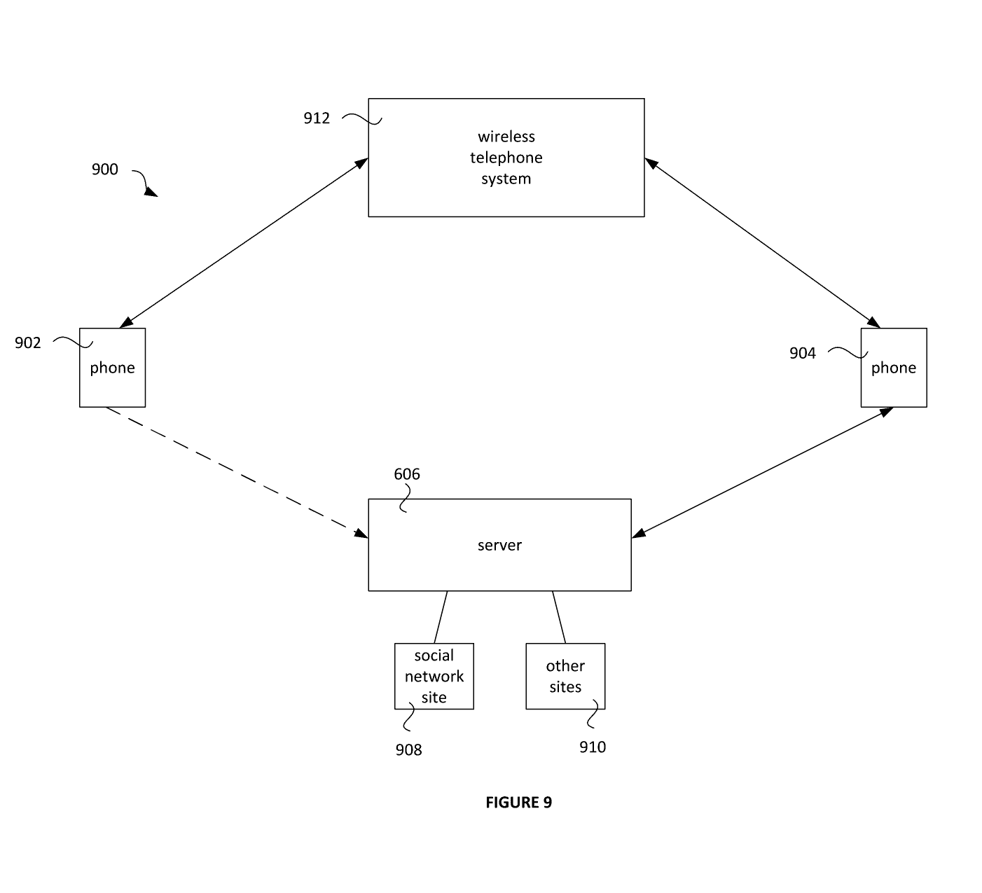

FIG. 9 shows an example where the reverse ringtone is sent across a network 900. A network can include a receiving device 902 and a sending device 904. The receiving device 902 has a first notification, such as a ringtone, that is normally provided by the receiving device 902 upon incoming messages. Receiving device 902 can provide a sender-selected notification, such as a reverse ringtone when the caller selects the sender-selected notification for the message. The sender-selected notification is provided at the receiving device 902 upon a message from the sender. The sending device 904 can allow the caller to select the sender-selected notification for the message.

In one embodiment, devices 902 and 904 can register with server 906 to allow for the providing of sender-selected notification, such as reverse ringtones, for audio notifications like normal ringtones. The server 906 can use telephone number and other information to determine whether to provide the sender-selected notification.

Upon an incoming message, such as a call, between device 902 and device 904, device 902 can obtain sender-selected notification and other information from server 906. The server 906 can obtain updates from social network sites 908 and other sites 910.

Alternately, the server 906 can provide pointers or links to these sites 908 and 910 and the device can independently get sender-selected notification and other information from sites 908 and 910. The device 902 can cache sender-selected notification and other information and update it as needed. When the message is a call, the server 906 can be part of or independent of a wireless telephone system 912 setting up the call.

The providing of the sender-selected notification for the first notification can be done by logic at the device. In one embodiment, the devices can act as peers that transfer the sender-selected notification, permission and/or other information independent of any server.

The receiving device 902 can also store sender-selected notifications locally. In that case, the receiving device 902 need only obtain a sender-selected notification from sending device 904 or server 906 if it is not stored locally.

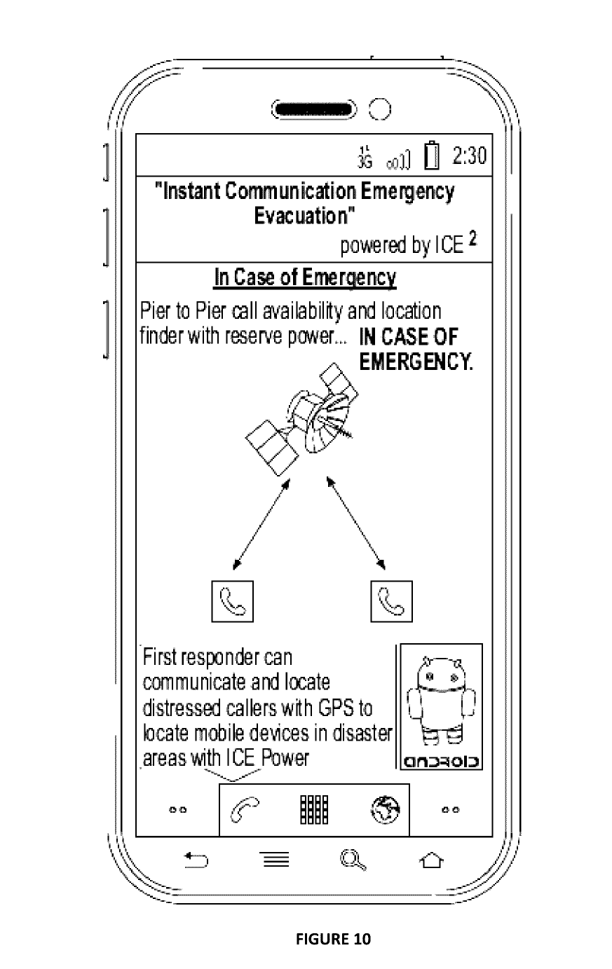

One example of the sender-selected of ringtone is described in U.S. Application No. 61/537,969 entitled: “PHONE WITH MULTI-PORTAL ACCESS FOR DISPLAY DURING INCOMING AND OUTGOING CALLS”, by Jason A. Ashton, filed Sep. 22, 2011 that is incorporated herein by reference. A section of this disclosure is copied below with FIGS. 15-17 renumbered as FIGS. 10-12.

FIG. 10 shows a screen for emergency features of a phone of one embodiment. A mobile safety feature can include reserved battery power that can only be used to receive and call. First responders can auto-turn on speaker phone and GPS on mobile devices in order to locate individuals that are in distress. The Mobile “SOS” systems can also auto-initiate calls to all known numbers resident to the disaster area, as well as phone numbers who have used cell towers in the disaster area prior to event.

The Mobile “SOS” enabled devices can also have emergency call interruption. Mobile SOS enabled devices provide selected individuals with an emergency interruption access via a password that allows callers to interrupt a call that is a Mobile enabled device. Callers with enabled devices can interrupt calls during emergencies by replacing ringtones with live voice, replacing ringtones with emergency message. The system enabled devices can interrupt and join live calls as third parties by auto triggering “call waiting” and automatically placing third party on “mute” for private communication between calling party and intended party.

In case of emergency, Mobile reserve power built into every handset is a powerful protection tool and product differentiator in the market place.

Embodiments of the present invention include a phone that automatically produces a display upon receiving or sending a call to another party that allows a simple messaging service (SMS) message to be sent to the another party to the call. When a phone call is received or sent in an outgoing call or incoming call, a field allow for a SMS message to be sent to the recipient during the call.

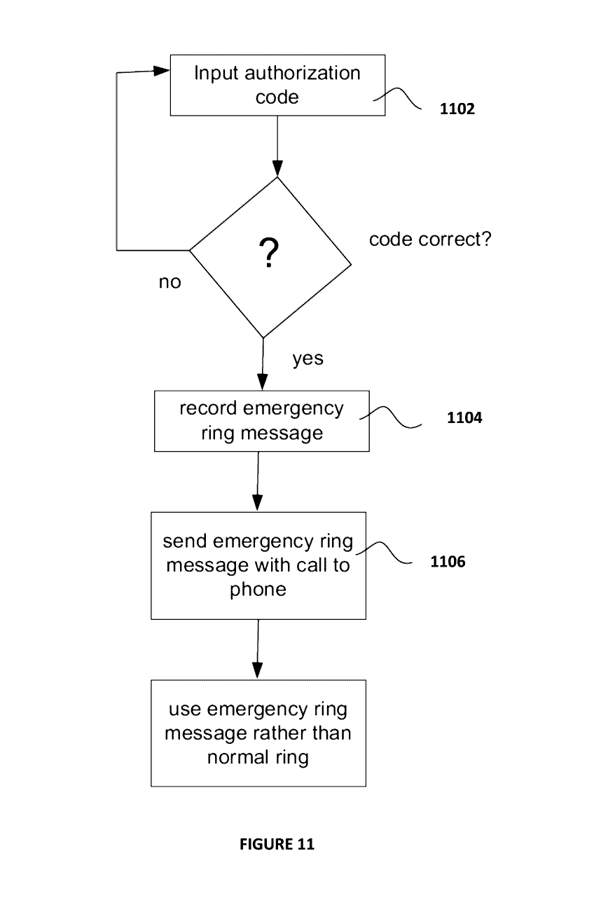

FIG. 11 shows a system that replaces a phone's ring with an emergency message created by the caller to the phone. The phone can allow the sender-selected of the normal ring when authorized using a pass code.

A pass code can be input by caller in step 1102. If the pass code is correctly input in step 1104, the emergency ring message can be recorded by the caller. In step 1106, this emergency ring message is sent to the recipient's phone. In step 1108, the recorded emergency ring message is used at the recipient's phone, rather than the normal ring. This feature allows for the call recipient's to send messages while talking on the phone. This functionality may be especially useful for conference calls or the like.

The caller can also use an auto interrupt feature which also may use a pass code.

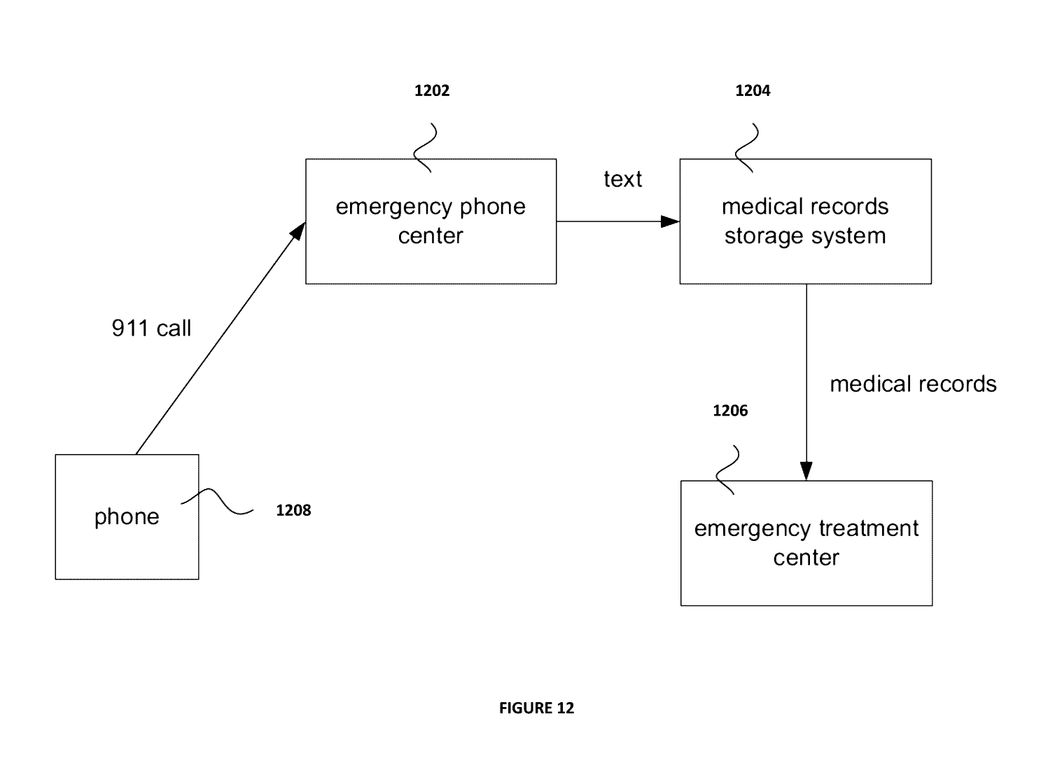

FIG. 12 shows an emergency system 1200 that allows an emergency phone center 1707 to automatically send a signal to a medical records storage system 1204 to release the medical records to an emergency treatment center 1206.

A phone 1208 is used to call the emergency phone center 1202, such as a 911 call center. The phone 1208 can be set up to authorize the transfer of medical records. Alternatively, the emergency phone center 1202 can check an authorization database (not shown).

The emergency phone center 1202 can send a message (such as a text message) to the medical records storage system 1204. The text message can include a code identifying the emergency location. The location of the medical record storage system can be provided by the phone 1208 or obtained from a database. The medical records storage system can be associated with a doctor's office for example.

The medical records can then be automatically sent to an emergency treatment center 1206 for use with respect to the patient. The emergency treatment center 1206 can be the location that treatment is to be given to the user, such as the destination hospital that an injured user is to be sent.

It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalents.

1. A device providing a sender-selected notification for the sender when the sender selects the sender-selected notification, wherein upon an incoming message from the sender the device provides a notification followed by the sender-selected notification.

2. The device of claim 1 wherein the notification is a warning notification.

3. The device of claim 2, wherein a delay between the warning notification and the sender-selected notification is selectable at the device.

4. The device of claim 2, wherein in-between the warning notification and the sender-selected notification a normal notification is provided.

5. The device of claim 1, wherein the notification is a normal notification.

6. The device of claim 1, wherein the device is a phone and the sender-selected notification is a reverse ringtone.

7. The device of claim 1, wherein the device allows a user to select which possible senders can provide a sender-selected notification.

8. The device of claim 1, wherein the device can allows for a user to select which possible senders need not have a warning notification before the sender-selected notification.

9. The device of claim 1, wherein the sender-selected notification is associated with a commercial offer.

10. The device of claim 1, wherein the device allows for a user to select if sender-selected notifications are to be disabled for the sender.

11. The device of claim 1, wherein the device is part of an open sender selected notification system that defaults to allowing senders to provide the sender-selected notifications.

12. A device providing a sender-selected notification for the sender when the sender selects the sender-selected notification, wherein upon an incoming message from the sender, the device provides the sender-selected notification and wherein the sender-selected notification is associated with a commercial offer.

13. The device of claim 12, wherein the commercial offer is displayed along with the sender-selected notification.

14. The device of claim 12 wherein the sender-selected notification is a commercial offer.

15. The device of claim 12, wherein the device is a phone and the sender-selected notification is a reverse ringtone.

16. The device of claim 12, wherein the device allows a user to select which possible senders can provide a sender-selected notification.

17. The device of claim 12, wherein upon an incoming message from the sender, the device provides a warning notification followed by the sender-selected notification.

18. The device of claim 12, wherein the device allows for a user to select if sender-selected notifications are to be disabled for the sender.

19. A phone providing a reverse ringtone when the sender selects the reverse ringtone for a call, the reverse ringtone being provided at the phone upon a call from the caller, wherein the phone concurrently provides a visual display identifying the caller by name, the identification not requiring a user of the phone to associate a name with a phone number.

20. The phone of claim 19, wherein a reverse lookup is used to determine the identification.

21. The phone of claim 19, wherein the reverse ringtone is analyzed to determine the identification.

22. The phone of claim 19, wherein the device allows for a user to select if reverse ringtones are to be disabled for the caller.

23. The phone of claim 19, wherein the device is part of an open system that defaults to allowing senders to provide the reverse ringtones.

24. A phone providing a reverse ringtone when the sender selects the reverse ringtone for a call, the reverse ringtone being provided at the phone upon a call from the caller, wherein the phone allows for reverse ringtones to be disabled for that caller.

25. The phone of claim 24, wherein the phone concurrently provides a visual display identifying the caller by name, the identification not requiring a user of the phone to associate a name with a phone number.

26. The device of claim 24, wherein the phone is part of an open system that defaults to allowing senders to provide the reverse ringtones.

27. A device providing a sender-selected notification for the sender when the sender selects the sender-selected notification, wherein upon an incoming message from the sender, the device provides the sender-selected notification and wherein the device is part of an open system that defaults to allowing senders to provide the sender-selected notifications.

28. The device of claim 27 wherein the open system uses an app obtained from a phone-based app store.

29. A sending device is used to select a sender-selected notification for a message at a receiving device, wherein the receiving device uses the sender-selected notification for the call and wherein the sending device uses the sender-selected notification for the message.

30. The sending device of claim 29, wherein the sending phone provides a visual display of an identifier for the sender-selected notification.

31. The sending device of claim 29, wherein the sender selected notification is used as the dial tone at the sending phone and as the ringtone at the receiving phone.
